(19) United States
(12) Patent Application Publication
(10) Pub. No.: US 2009/0249338 A1
(43) Pub. Date: Oct. 1, 2009

(54) METHOD AND SYSTEM TO MODIFY TASK IN A WORKFLOW SYSTEM

(76) Inventor: Ajmal M. M. Beg, Runcorn (AU)

Correspondence Address: Ajmal M. M. Beg, 78/134 Hill Road, Runcorn, QL, 4113, AU

(21) Appl. No.: 12/058,045

(22) Filed: Mar. 28, 2008

(51) Int. Cl. G06F 9/46

(52) U.S. Cl. 718/100

(57) ABSTRACT

Delegatee of a task in workflow system receives data related to task to be performed. This invention realizes a method and system which provides capability to the said delegatee to initiate the process of modifing to tasks which resemble the task delegated to the delegatee. This capability given to the delegatee to initiate the process of modification of resembling tasks is realized by creating a modification task data which includes rules which identifies the resembling tasks in the workflow system; information regarding proposed modification to the resembling tasks in the workflow system and information which identifies the delegatee of the modification task data.

### TECHNICAL FIELD AND INDUSTRIAL APPLICABILITY OF THE INVENTION

This invention relates to a method and system to modify task in application program, and to a machine readable medium containing instructions to perform this method.

### BACKGROUND

Tasks are delegated and their progress is monitored. For example, a machine mechanic is delegated an engineering task by his manager and the progress of this delegated task is monitored until its completion. Workflow systems and non-work flow systems such as e-mail clients are used for delegating and monitoring tasks.

Workflow control method and system described in U.S. patent application Ser. No. 11/183,272 discloses a method that can be used to delegate and monitor the tasks. In the method described, a delegator delegates a task to delegatee and monitor its progress. The delegator also reviews the task and generates a task revocation data, if necessary. Revoking a task as described in U.S. patent application Ser. No. 11/183,272 may result in additional step of replacing the revoked task by creating a new task and delegating it to a delegatee. Modifying an existing task rather than revoking is an efficient approach compared to the approach of going through the process of revoking an existing task and; further creating and delegating a new task to a delegatee. The described workflow control method in U.S. patent application Ser. No. 11/183,272 is useful in a scenario where the delegator has higher capability compared to the delegatee in respect to reviewing the delegated task and additional steps of creating a new task to replace the revoked task is not considered inefficient. In many cases, the delegatee has higher capability to review the delegated task compared to the delegator. For example, an experienced accountant may have higher capability to review the account transaction details in a delegated task to him/her and tasks which are not delegated to him/her but resembles the delegated task compared to the manager of the accounting department who mainly performs managerial duties and is not much capable to review tasks. Allowing a capable delegatee the ability to review and modify tasks that resemble the delegated task can increase the efficiency of the tasks that need to be performed. Here, task which resembles the task delegated to the said delegatee is referred as Resembling Task. A resembling task need not to be instance of the same type of task or share the same parent task type. A task and its resembling task can have common data which may be a candidate of modification. Therefore, there is a need for a method which gives the delegatee of a task, the capability of initiating process of modifying the tasks that resembles the delegated task based on the review of the delegated task.

### BRIEF DESCRIPTION OF THE DRAWINGS

The accompanying drawings together with the description, serve to explain the principles of the invention.

FIG. 1 illustrates the state of art of revoking tasks according to U.S. patent application Ser. No. 11/183,272;

FIG. 2 is a diagrammatic representation of a relationship between delegatee, delegator, assigned task and modification task in an example embodiment of the present invention;

FIG. 3 is a block diagram showing a system to create modification to the resembling tasks, according to an example embodiment of the present invention;

FIG. 4, is a block diagram showing different data structure and logic used in creating modification task, according to an example embodiment of the present invention;

FIG. 5 is a general flow diagram of method used initiating the process of modification to the resembling task, according to an example embodiment of the present invention;

FIG. 6 is a diagrammatic representation of a exemplary machine which can execute the set of instructions to perform the example embodiment of the present invention.

### DETAILED DESCRIPTION

Delegatee of a task in workflow system receives data related to task to be performed. According to an aspect of the invention there is provided a method and system which provides capability to initiate the process of modifications to tasks which resemble the task delegated to the delegatee. This capability given to the delegatee to initiate the process of modification of resembling tasks is realized by creating a modification task data by the delegatee which includes rules which identifies the resembling tasks in the workflow system, information regarding proposed modification to the resembling tasks in the workflow system and information which identifies the delegatee of the modification task data. Activity, action, obligation or step in any application domain is an example of a ‘Task’.

While exemplary features and embodiment of the present invention are described herein, modifications and other implementations can be possible without departing from the scope and spirit of the present invention. The following detailed description does not limit the scope and spirit of the invention. Instead, the appended claims define the proper scope of the present invention.

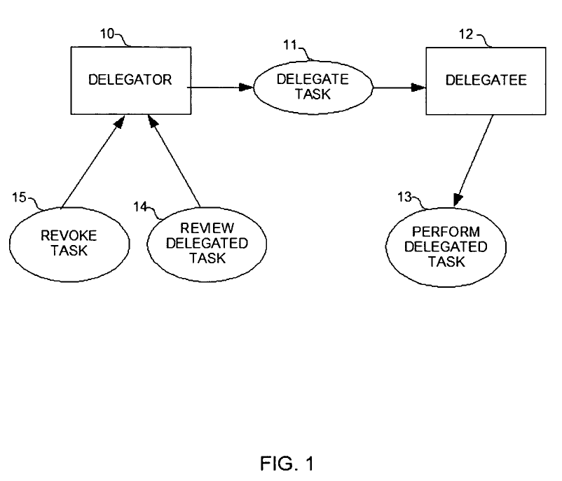

FIG. 1 illustrates the prior art of revoking tasks according to U.S. patent application Ser. No. 11/183,272. Delegator 10 delegates the task 11 to delegatee 12. Delegatee 12 performs the delegated task 13. Delegator 10 reviews the delegated task 14 and revoke the task if necessary 15.

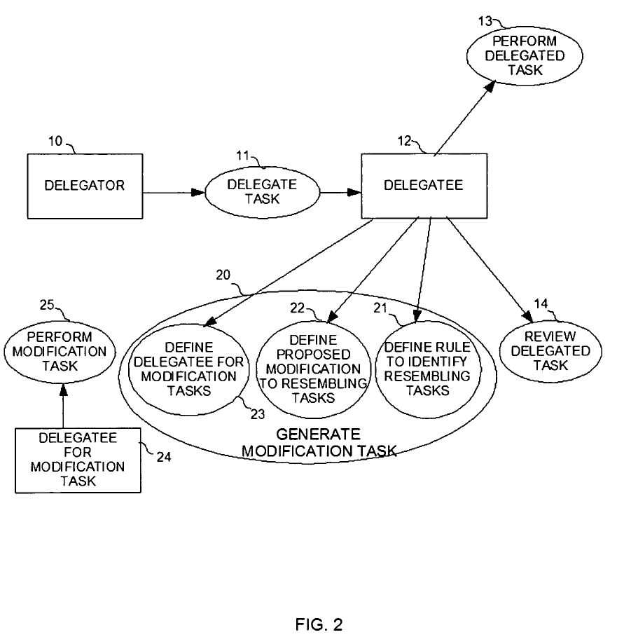

FIG. 2 illustrates the exemplary embodiment according to present invention. Task 11 is delegated from delegator 10 to delegatee 12. Delegatee 12 reviews the delegated task 14. Delegatee 12 perform the delegated task 13 after reviewing it 14. Delegatee 12 generates a modification task 20 when delegatee 12 identifies need for improvement. Modification task 20 is also referred as modification task data. Generation of modification task 20 consists of three steps; (a) Delegatee 12 defines rules with identifies the resembling tasks 21; (b) Delegatee 12 further defines proposed modifications to the resembling tasks 22 identified by rules set to identify resembling tasks 21 ; (c) Delegatee 12 further defines who is to perform the modification task 23. Steps (b) and (c) may happen in any order. The delegatee 24 selected in step (c) performs the modification task 25. Performing the modification task 25 results in modification to the resembling task.

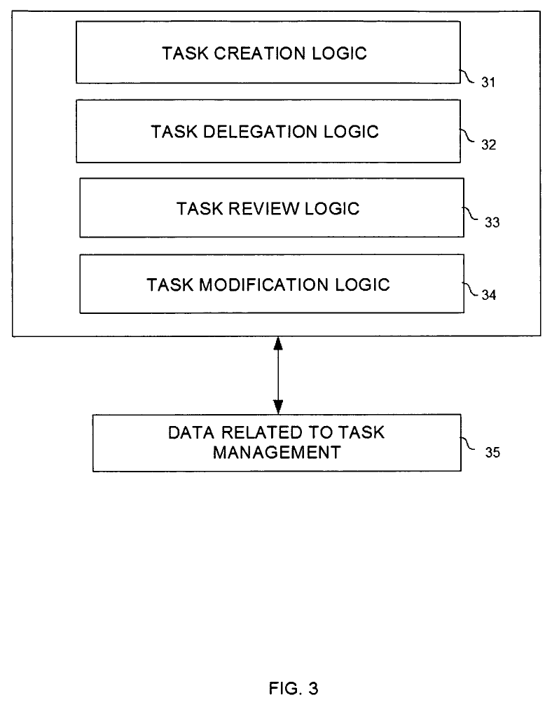

FIG. 3 is a block diagram showing a system including capability for the delegatee 12 to initiate the process of modification to resembling tasks, according to an example embodiment of the present invention. Tasks are created by task creation logic 31. Task review logic 33 reviews the task delegated to the delegatee 12. The task review logic 33 may use information stored in database containing data related to the tasks 35 and it may also use information provided by the delegatee 12 through a user interface. The task delegation logic 32 delegates tasks to delegatee 24. Delegatee 24 may be selected using different ways. For example, in one embodiment delegatee 24 may be selected using rules stored in database containing data related to the tasks 35. In another embodiment, delegatee 24 may be selected using user role information stored in database containing data related to the tasks 35. Delegatee 24 does not need to be a single person. Delegatee 24 can be a group of persons. Delegatee 24 can be the same as the delegator 10. Task modification logic 34 define resembling tasks 21 and the proposed modification to these resembling tasks 22. Here, the resembling tasks 22 are tasks which are generated by task creation logic 31 and becomes candidate for modification based on review by delegatee 14.

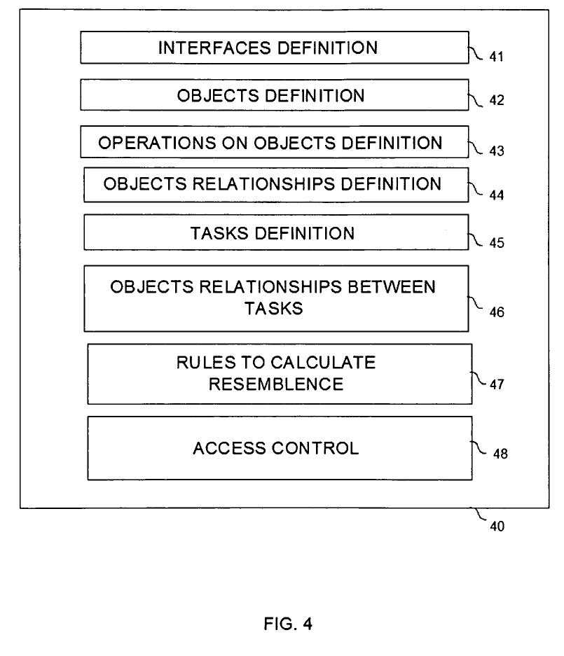

FIG. 4 is a block diagram showing different data structures and logic 40 used in generating modification task 20 by task modification logic 34, according to an example embodiment of the present invention. In this example embodiment of the present invention, data structures and logic 40 are part of data related to task management 35. Objects Definition 42 are data structures which contain the definition of data objects which are used to define tasks. Objects Relationships Definitions 44 contain information about relationships between data objects defined in the Object Definitions 42. Parent-child relationship is an example of such relationship 44. Tasks Definition 45 contains objects 42 and relationships 44 that exist between objects 42 of each task. Object Relationship Between Tasks 46 contains information about relationships 44 that exists between objects 42 belonging to different tasks defined in Tasks Definition 45. Rules To Calculate Resemblance 47 are data structures and/or logic which define rules that are used to calculate resemblance between objects 42 that belong to different tasks defined in Tasks Definition 45. Operation On Objects Definitions 44 are the data structures and/or logic which define operations that can be performed on objects 42 which form a task defined in Tasks Definition 45. Operation On Objects Definitions 44 and Object Relationship Between Tasks 46 are used to describe the modifications to the tasks in Tasks Definition 45. Interfaces Definition 41 contains data structures and logic to exchange the information in different data structures and logic 40 with external logic.

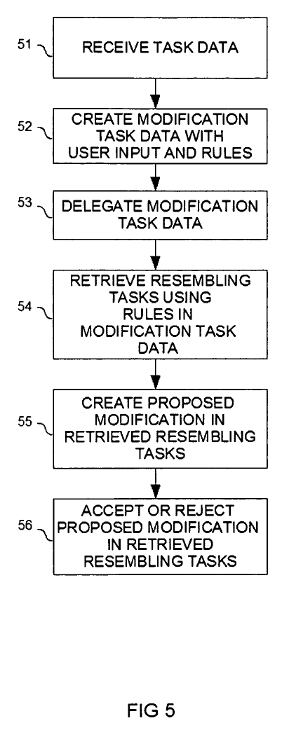

FIG. 5 is a general flow diagram of method used initiating the process of modification to the resembling task, according to an example embodiment of the present invention. At operation 51, delegatee 12 receives the task data. At operation 52 Modification Task Data is created. Operation 52 consists of two steps. First step defines the Resembling Tasks by using Objects Relationship Between Tasks 46 and Rules To Calculate Resemblance 47. Delegatee 12 inputs through a user interface and/or stored information may be used to select Object Relationship Between Tasks 46 and Rules To Calculate Resemblance 47 used in defining the Resembling Tasks related to the task delegated to delegatee 12. The second step generates the proposed modifications to the resembling tasks using rules. Operations On Objects Definitions 43 are used to describe these rules. Delegatee 12 input through a user interface and/or stored information may be used to assign values to undefined parameters of these rules. Stored rules such as rules that were frequently used in past may be also used. At operation 53, Modification Task Data is delegated to delegatee 24. At operation 54, Resembling Tasks are retrieved using rules which define the Resembling Task in Modification Task Data by delegatee 24. At operation 55, modifications are created on the retrieved resembling tasks. At operation 55, the modifications may be accepted or rejected by delegatee 24. In case modifications are accepted, modified task data is stored.

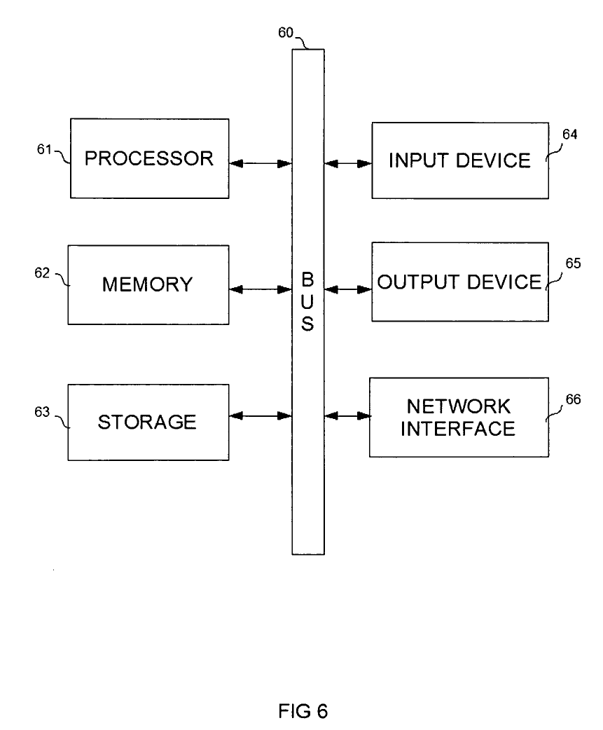

FIG. 6 shows a block diagram of an example computer system on which the computer instructions can execute to implement the methods of the present invention. Processor 61 can be any computing device such as laptop, server, mainframe, digital signal processor. Memory 62 can be any kinds of memory device such as read only memory (ROM), random access memory (RAM) and flash memory. Storage 63 can be any medium which can be used as a persistence storage. For example, hard drive, tape drive, optical disk drive and disk arrays. Input device 64 is used to input external data and can be any kind of input device such as mouse, trackball or light pen. Output device 65 can be any kind of device used for data output . For example, cathode-ray-tube (CRT) monitor, plasma display or crystal display. Network interface 66 can be any kind of network interfaces such as ISDN, ADSL, FDDI. Bus 60 is used to communicate information and commands between different sub components 61, 62, 63, 64, 65, 66. Bus 60 can be implemented using any kind of data transfer technology such as USB, serial connection, parallel connection and circuit board connections.

It is to be understood that while the detailed description describes the present invention, the foregoing description is for illustrative purpose and does not limit the scope of the present invention which is defined by the scope of the appended claims. Other modifications and aspects are within the scope of the following claims.

What is claimed is:

1. A method to modify at least one task in a workflow system, the method comprising:
receiving task data where the said task data includes information regarding task to be performed;
creating modification task data including:
a. at least one rule which is used to identify at least one resembling task relevant to the said received task data.
b. information regarding at least one proposed modification to at least one said resembling task in the workflow system.
c. information which is used to identify at least one delegatee of the said modification task data.
storing said modification task data.

2. The method of claim 1, wherein the said delegatee is identified using at least one rule.

3. The method of claim 1, wherein the said delegatee is at least one group of users.

4. The method of claim 1, wherein the said delegatee is at least one user role.

5. The method of claim 1, wherein the said delegatee change at least one said resembling task identified by at least one said rule in claim 1, based on information initiated by a user input device.

6. The method of claim 1, wherein the said delegatee change at least one said resembling task identified by at least one said rule in claim 1 by using at least one rule different to that at least one said rule in claim 1.

7. The method of claim 1, which allows accepting or rejecting proposed modifications to at least one resembling task based on information initiated by a user input device.

8. The method of claim 1, wherein at least one said proposed modification to at least one said resembling task is accepted or rejected based on at least one rule.

9. A machine-readable medium storing sequence of instruction which can be executed by a computing device and perform the method of claim 1.

10. A system to modify at least one task in a workflow system, the system comprising:
first means for receiving task data where the said task data includes information regarding task to be performed;
second means for creating modification task data which includes:
a. at least one rule which is used to identify at least one resembling task relevant to the said received task data.
b. information regarding at least one proposed modification to at least one said resembling task in the workflow system.
c. information which is used to identify at least one delegatee of the said modification task data.
third means for storing said modification task data.

11. A system of of claim 1, further including means to identify the said delegatee using at least one rule.

12. A system of claim 1, further including means to assign at least one group of users as the said delegatee.

13. A system of claim 1, further including means to assign at least one user role as the said delegatee.

14. A system of claim 1, further including means for the said delegatee to change at least one said resembling task identified by at least one said rule in claim 1, based on information initiated by a user input device.

15. A system of claim 1, further including means for the said delegatee to change at least one said resembling task identified by at least one said rule in claim 1 by using at least one rule different to that at least one said rule in claim 1.

16. A system of claim 1, further including means to allow accepting or rejecting proposed modifications to at least one resembling task based on information initiated by a user input device.

17. A system of claim 1, further including means to accept or reject at least one said proposed modification to at least one said resembling task based on at least one rule.
